(19) United States
(12) Patent Application Publication
(10) Pub. No.: US 2025/0333630 A1
(43) Pub. Date: Oct. 30, 2025

(54) LASER-MARKABLE SEALING COMPOUNDS WITH OXYGEN ABSORBERS

(71) Applicant: ACTEGA DS GMBH, Bremen (DE)

(72) Inventors: Simon Heyder, Ganderkesee (DE); Waldemar Eichler, Bremen (DE); Katharina Bahrs, Wildeshausen (DE)

(21) Appl. No.: 18/293,403

(22) PCT Filed: Apr. 6, 2023
(86) PCT No.: PCT/EP2023/059284

§ 371 Date: Jan. 30, 2024

(30) Foreign Application Priority Data
Apr. 8, 2022 (WO) PCT/EP2022/059547

(51) Int. Cl. C09K 3/10

(52) U.S. Cl. CPC C09K 3/10; C09K 2200/0213; C09K 2200/023; C09K 2200/0239; C09K 2200/0617; C09K 2200/0632

(57) ABSTRACT

Receptacle closure made of metal, with a sealing insert that is arranged in the receptacle closure in such a way that it comes into contact with the mouth of the receptacle when the receptacle closure is positioned on the receptacle, wherein the sealing insert contains or is made from a sealing compound that includes at least 10% by weight, preferably at least 40% by weight LDPE relative to the total weight of the sealing compound, in particular with butene, hexene or octene as comonomer besides contents of LLDPE and/or OBC and a content of more than 2% by weight of at least one oxygen-absorbing compound, preferably sodium sulfite.

The invention relates to sealing compounds that contain oxygen absorbers for the purpose of forming seals in receptacle closures. The invention further relates to sealing compounds of such kind that are laser markable.

Receptacle closures made of metal have been known for a long time. In the form of screw caps, twist closures and crown corks, for example, they are used to create a sealed closure for receptacles such as bottles, jars, and the like. Such receptacles have a mouth which must be closed off by the receptacle closure. At the same time, the closure of the receptacle must be sufficiently well sealed to guarantee not only that the receptacle contents cannot escape, but also that the contents are protected against the ingress of unwanted substances, including gaseous substances like oxygen, trichloranisole and others.

The requisite impermeability is usually achieved with a sealing insert made from a material that is not only sufficiently firm on the one hand, but elastic on the other hand, and is arranged in the receptacle closure in such a way that it comes into contact with the mouth of the receptacle when the receptacle closure is positioned on the receptacle. In most cases, the sealing insert is arranged on the inside of the receptacle closure in the form of a disc. With the receptacle in the closed state, it fits over the receptacle mouth and is pressed against the mouth by the receptacle closure, the seal being assured by its hardness and its elasticity. A good sealing insert compensates for the ever-present unevennesses of the receptacle mouth. For this reason, the more uneven the receptacle mouth, the greater the demands that are placed on the sealing insert.

In the following text, we will tend to use the terms “sealing insert”, “sealing compound” and “sealing material” as synonyms, which seems justified when the sealing insert, as is usual, is a body that consists substantially or entirely of the sealing material/sealing compound.

Sealing materials which must guarantee sufficient impermeability for weeks or months are often equipped with additives that eliminate undesirable contaminants which are not prevented from infiltrating effectively enough by the sealing insert. A known example of this are additives (also called “scavengers” or “oxygen absorbers”) to the sealing material, which remove oxygen that gets into the closed receptacle despite the seal.

Oxygen absorbers are therefore known auxiliary agents for prolonging the storage life of beverages and foodstuffs and for keeping the taste-particularly of beverages-fresh for longer. For this purpose, various technologies may be used, wherein systems based on ascorbates and alkali metal sulfites are most widely used for closure sealing compounds.

The prior art includes references to a number of examples of this:

GB8803065 describes a series of systems with both PVC-containing and PVC-free sealing materials, in which both ascorbates and sulfites can be used.

WO1991017044A1 focuses on PVC-based seals in which ascorbates are used as oxygen scavengers, and the trapping reaction is accelerated by the use of transition metal catalysts.

WO2011069520A1 focuses on a more specific PVC-free sealing compounds that are optimised in particular for twist crown corks and contains sulfite-based oxygen scavengers in particularly small particle sizes.

A common feature of all these systems is that they are activated by water (vapour) and optionally at temperatures such as are used during pasteurisation of drinks (60-70° C.).

However, these known systems are entirely lacking in the transparency necessary for the uses essentially addressed with this invention:

It is common practice for drink manufacturers to launch sales boosting measures, or “promotions”, at regular intervals, with competitions, for example, in which customers can participate using codes (also referred to generally in this application as “symbols”, often alphanumeric, barcodes or QR codes) printed in the closure.

Such codes are often printed on the inside of the closure before the sealing material is applied. In such circumstances, the sealing material contained in the closure, which in most of the cases described here partly or completely covers the symbols, i.e. the code for example, must be transparent enough to allow the code to be read/scanned effectively. Since in the case of beverage bottles, for example, relatively long periods may elapse between filling and consumption (weeks or even months), throughout which the seal must continue to perform its sealing function, it is no small task to provide sealing inserts that will remain transparent for the long term.

Following the trend observed in recent years of avoiding the use of PVC in packaging materials as far as possible, in particular because of the plasticisers needed to produce it, ascorbates are becoming less important as oxygen scavengers, as they do not respond well to the high temperatures necessary for compounding PVC-free sealing materials. Therefore, alkali metal sulfites are preferred as oxygen absorbers according to the invention.

Due to their reaction with oxygen, particularly the alkali metal sulfites bind water effectively, which is stored in the plastic material close to the particles. This often causes otherwise transparent/translucent materials to become cloudy. This cloudiness becomes more pronounced as more and more oxygen is absorbed in the sealing material. In addition, a change takes place in the surface of the sealing material, which tends to result in a rough “spotty” surface.

In the past, for the reasons given above the drink manufacturers were limited in their choice of sealing material to transparent systems without the addition of oxygen absorbers if they were to achieve the minimum shelf lives of 12 months and longer that represent the market standard.

The solution approach presented by us in PCT/EP2021/053762 (WO 2022/174887), involving a combination of passive oxygen barrier and a small quantity of oxygen scavengers (generally in the region of 2% by weight) to make products suitable for promotions is still too limited with regard to shelf life for some applications. More specifically, WO 2022/174887 discloses a sealing compound containing 73% by weight LDPE, 10% by weight SIBS, 15% by weight LLDPE, 1% by weight Na sulfite, the remainder being customary additives. According to claim 1, the content of oxygen scavengers cannot be greater than 2% by weight relative to the total weight of the sealing compound. No provision is made for laser marking components. The full content of that document is herewith also incorporated in this disclosure by reference.

An alternative technology to printing for applying symbols, particularly codes, to the inside of closures is the use of lasers, for example with “mark-on-the-fly” technique, which enables distortion-free marking of paints or sealing materials even as the unit to be marked is travelling at high speeds. Accordingly, with this marking technique the code does not have to be printed on the inside of the closure, it is created in the paint or sealing material with a laser. In these cases too, it must be possible to read/scan the code through the sealing material.

However, in order to attain the requisite high marking speeds, the aluminium-based pigments suggested by us in DE502007005584D1 for this purpose must be added in quantities that may result in undesirable greying of the plastic matrix.

The ability of QR codes to be scanned with smartphone cameras has grown increasingly important in recent years. Besides simply linking websites with the opened closure, possible applications also include connecting with location or user information, which for advertising purposes offers an extremely interesting prospect of interaction with the consumer, particularly the beverage consumer.

Scannability is considered to be viable in particular when the respective smartphone camera detects the barcode or QR code and is consequently able to correctly read out a website or the coded information via an app.

Although US20120316280A1 suggests an additive package of TiO₂/ZnO for marking thermoplastic elastomers with UV lasers, such lasers are considerably more complicated and more expensive than the Nd:YAG IR lasers used widely in the field of plastics.

In the light of the clouding and surface altering effects described in association with scavenger sealing materials, it would seem contradictory to endow such sealing materials with additives for laser markings. It must be expected that when they are used on the filling material the surface undergoes such alteration that the corresponding codes are no longer readable, or can no longer be scanned with smartphone cameras.

Against this background, one of the problems addressed by the invention is to disclose sealing materials that are also suitable for laser marking and are able to absorb more penetrating oxygen than the sealing materials known from the prior art.

The feature combinations defined in the independent claims serve to solve this problem.

Advantageous embodiments of the invention are defined in the dependent claims.

The invention provides sealing materials that absorb oxygen for longer than conventional sealing materials suitable for laser marking without sacrificing their sealing effect.

Surprisingly, it was found that with a combination of laser marking additives with alkali metal sulfites having particular particle sizes (D₉₀<20 μm, measured by laser light scattering) in sealing materials, even laser-engraved QR codes after several weeks of “forced aging” (i.e. storage at elevated ambient temperature of 38-42° C.) exhibited improved rather than degraded scannability.

Surprisingly, a large bandwith with tolerated additives and matrices was also found for marking with infrared (IR) laser (wavelength approx. 1064 nm fibre laser/Nd:YAG).

The invention may be used with a variety of closures that have a full-area seal inserted, particularly crown corks, ringpull caps, aluminium closures, and plastic closures.

The seal is preferably permanently attached to the closure, but it may also be provided as a disc fitted in the closure.

The seal according to the invention provided in the closure guarantees scannability with commercially available smartphone cameras.

Preferred additives for the laser marking include:
Aluminium-based additives (metal particles),
Additives based on antimony oxide and/or tin antimony oxide.

The additives for the laser marking are used in quantities that are harmonised with the requirements of the seal. Typical embodiments contain <1% by weight laser marking additive. Often, smaller contents are sufficient, e.g. 0.1%, or <0.01%, or even just <0.005%.

White pigments such as titanium dioxide (TiO₂) may be contained, but do not have to be used, particularly with progressive cloudiness/white discolouration of the seal during use, good contrast is maintained even without the addition of the pigment, allowing scannability. The addition enables a consistent appearance for the entire period of use of the closure system, and better visualisation or look.

In all cases, sealing compounds of the invention contain a polyolefin component, preferably in a quantity of 30 to 80% by weight relative to the total quantity of sealing compound. In preferred embodiments, the polyolefin component consists mainly of LDPE. In other embodiments, it contains, usually additionally, (co-)polyolefins such as HDPE, LLDPE, PP, propylene-ethylene copolymers, copolymers with contents of butene, octene and the like.

Preferred embodiments of the sealing compounds contain styrene block copolymers such as OBCs and SBCs, mostly in quantities of 10 to 40% by weight relative to the total quantity of sealing compound.

Preferred embodiments of the invention contain 5 to 40% by weight medicinal white oil in the sealing compound. If SBS is used, an SBS/white oil proportion greater than 2:1 is preferred: if SEBS and/or SEEPS is/are used, a proportion greater than 0.7:1 is preferred.

In preferred embodiments of the invention, the sealing compound contains up to 20% by weight EVA relative to the total quantity of sealing compound.

The oxygen absorbing compound content preferably consists of sodium sulfite, and is generally above 2% by weight, preferably from 3 to 20% by weight Na₂SO₃, particularly preferably 4 to 15% by weight sodium sulfite, here too relative to the total quantity of sealing compound.

TiO₂ or other white pigments (e.g., Ba₂SO₄) may be used as the pigment.

The following recipes according to the invention are particularly suitable for the use stated in each case:

| Twist crown | % |
|---|---|
| Med. white oil | 31 |
| SEBS (styrene cont. 29-33%) | 25 |
| LLDPE | 15 |
| Na₂SO₃ | 10 |
| LDPE | 10 |
| coPP | 8 |
| Additives | 0.7 |
| TiO2 | 0.3 |
| | 100.0 |

| Pry-off crown | % |
|---|---|
| LDPE | 40.5 |
| SBS (29-31% styrene cont.) | 22 |
| Med. white oil | 11 |
| LLDPE | 18 |
| Na₂SO₃ | 8 |
| TiO₂ | 0.300 |
| Stabilisers | 0.2 |
| | 100.0 |

| Ringpull 1 | % |
|---|---|
| LDPE | 76.5 |
| LLDPE | 15 |
| Na₂SO₃ | 8 |
| TiO₂ | 0.3 |
| Stabilisers | 0.2 |
| | 100 |

| Ringpull 2 | % |
|---|---|
| LDPE | 81.5 |
| OBC | 10 |
| Na₂SO₃ | 8 |
| Stabilisers | 0.2 |
| TiO₂ | 0.3 |
| | 100 |

In all cases, the scavenger content is significantly higher than in WO 2022/174887; surprisingly, the expected problems with reading/scanning due to cloudiness or the like did not arise, even though the sodium sulfite used here (particle size D₉₀<20 μm, measured by laser light scattering) is similar to the sodium sulfite according to WO2022/174887.

The aforementioned laser marking additives could be added to all of the recipes named above in the quantities required for marking, up to 1% by weight, without loss of the sealing effect. Even without said laser marking additives, the sealing compounds described above are suitable for the purposes disclosed in WO 2022/174887.

1. A closure for a receptacle, the closure made of metal with a sealing insert that is arranged in the receptacle closure in such a way that it comes into contact with the mouth of the receptacle when the receptacle closure is positioned on the receptacle, wherein the sealing insert comprises a sealing compound that includes at least 10% by weight LDPE relative to the total weight of the sealing compound, and a content of more than 2% by weight of at least one oxygen-absorbing compound.

2. The closure according to claim 1, in which the sealing compound further includes at least one SEBS or SIBS styrene block copolymer.

3. The closure according to claim 1, in which the sealing compound further includes a content of 5 to 40% by weight oil relative to the total weight of the sealing compound.

4. A closure for a receptacle, the closure made of metal with a sealing insert that is arranged in the receptacle closure in such a way that it comes into contact with the mouth of the receptacle when the receptacle closure is positioned on the receptacle, wherein the sealing insert comprises a sealing compound that includes contents of polyolefin and at least one oxygen-absorbing compound, wherein the closure has a non-zero content of at least one laser marking substance.

5. The closure according to claim 4, in which the laser marking compound is a component of the sealing insert.

6. The closure according to claim 4, in which the laser marking compound comprises metal particles.

7. The closure according to claim 4, in which the closure contains up to 1% by weight, laser marking compound.

8-10. (canceled)

11. The closure according to claim 1, where LDPE is present in said sealing insert in an amount of at least 40% by weight.

12. The closure according to claim 1, said oxygen-absorbing compound comprising sodium sulfite.

13. The closure according to claim 1, said sealing insert further comprising, as one or more comonomers, one or more of butene, hexene, or octene

14. The closure according to claim 1, said sealing insert further comprising, as one or more comonomers, one or more of LLDPE or OBC.

15. The closure according to claim 2, said styrene block copolymer being present in a proportion of 10 to 40% by weight relative to the total weight of the sealing compound.

16. The closure according to claim 3, said oil comprising white oil having a kinematic viscosity at 40° C. of 60 to 150 cSt.

17. The closure according to claim 4, said polylefin comprising LDPE.

18. The closure according to claim 6, said laser marking compound comprising metal particles based on antimony oxide, tin antimony oxide, and/or aluminum.

19. The closure according to claim 7, in which the closure contains up to 0.1% by weight laser marking compound.
